(19) United States
(12) Patent Application Publication
(10) Pub. No.: US 2003/0204975 A1
(43) Pub. Date: Nov. 6, 2003

(54) Lighted signage method and apparatus

(76) Inventors: Lee B. Holder, Greenwood, SC (US); Brad M. Boozer, Greenwood, SC (US)

Correspondence Address: MICHAEL A. MANN, NEXSEN PRUET JACOBS & POLLARD LLC, PO DRWR 2426, COLUMBIA, SC, 29202-2426, US

(21) Appl. No.: 10/136,836

(22) Filed: May 2, 2002

(51) Int. Cl. G09F 13/00

(52) U.S. Cl. 40/552; 40/597

(57) ABSTRACT

A sign comprises a frame (12) formed in the shape of a team or player logo, outlined by light rope (12) and fitted with suction cups (18) on the front of the sign. The rope light (10) is securely tied to frame (12) and connected to a cigarette lighter adapter (14) so that it can be provided with electrical power from a car battery and displayed from inside a car window.

### BACKGROUND OF THE INVENTION

The present invention relates generally to signage and in particular to lighted signs used by those who wish to show support or affiliation with a particular team or individual.

In addition to more traditional neon signs, those who wish to decorate their homes or both to decorate and to advertise their commercial premises now may use a material known generally as “rope light.” Rope light is a flexible plastic housing that holds a series of lights in a closely spaced linear array of about one bulb per inch. Typically the bulbs are small incandescent bulbs but may also be light emitting diodes (LEDs). Rope light has been used in a variety of applications from outlining buildings to wrapping trees, to forming into artwork in discos and bars. In the first of these examples, light rope may be held in position with suction cups and cable ties and supported by U-shaped channels. In the last of these three examples, a metal frame is fashioned into the desired artistic shape and the rope light is secured to frame 10 using wire ties. Christmas decorations made according to this construction technique are sold to homeowners for use in decorating their homes. Typically, the rope light is powered by plugging it into a standard 120 VAC power line.

Many sports teams and individual athletes enjoy strong support from those who follow their team or have an affiliation with the school or city that hosts the team. Fans show their support by displaying all sorts of goods carrying the team logo or team colors. Typically, team logos are printed onto tee-shirts and caps. It is also not uncommon, for example, to see cars driving toward the stadium where an athletic contest is to take place having flags with team logos fluttering from short masts extending from clips attached to the top edges of car windows.

US Patent Publication No.: 2001/0022724 A1 describes a spirit light decoration comprising a series of light bulbs mounted to outline a frame formed to depict symbols of holidays, sports and school. This spirit light decoration may be powered by AC or DC, including a 12 volt car battery using an inverter to change the direct current from the battery to alternating current for powering the series of light bulbs.

Although lighting on vehicles other than the usual, required headlights and safety lighting, and of course, interior lighting for passenger convenience, is uncommon, tractor-trailer rigs have been known to have outline lighting and even ornamentation on the radiator grille.

However, there remains a need for additional ways for fans to show their support.

### SUMMARY OF THE INVENTION

According to its major aspects and briefly recited, the present invention is an apparatus and method for making the apparatus for providing an illuminated sign in the form of a team logo or player number suitable for display in the window of a vehicle.

The apparatus comprises a metal frame to which light rope is attached, preferably using wire ties, and powered by an adaptor made for use in a cigarette lighter of a vehicle. Frame 10 carries a suitable number of suction cups for use in securing the apparatus to a vehicle window.

An important feature of the present invention is the use of rope light in a scale small enough to depict a team logo, for example, to be mounted to the inside of a car window. Rope light is known for outlining buildings and for larger scale artwork and decorations; in a vehicle window, the scale is much smaller. However, for outlining a logo or letter to be used in a vehicular window, somewhat surprisingly, rope light works well.

Another important feature of the present invention is the cooperation of suction cups and a cigarette lighter adapter. These two features make it convenient for rope light attached to the inside of a vehicle window. Suction cups permit secure attachment to the window even during movement of the vehicle; the cigarette lighter adapter makes it possible to supply power to the rope light from within the vehicle.

These and other features and their advantages will become apparent to those skilled in the art of lighted signage from a careful reading of the Detailed Description of Preferred Embodiments, accompanied by the drawings.

### BRIEF DESCRIPTION OF THE DRAWINGS

In the drawings,

FIG. 1 is the letter G illuminated in accordance with a preferred embodiment of the present invention; and

FIG. 2 is a detailed cross sectional view of the letter G illuminated in accordance with a preferred embodiment of the present invention.

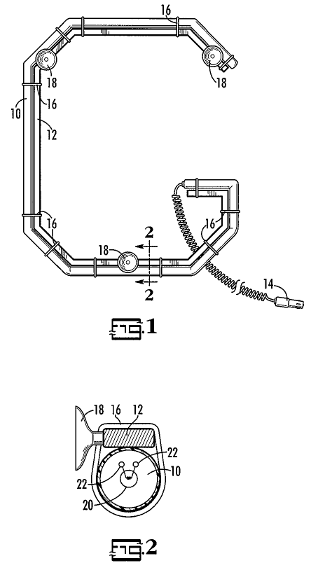

### DETAILED DESCRIPTION OF PREFERRED EMBODIMENTS

The present invention is an apparatus and method for making the apparatus intended for use in a vehicle for allowing a user to demonstrate support for a team or particular athlete. The apparatus comprises a light rope 10 secured to a frame 12 by wire ties 16 and powered by converting 12 volt direct current to 120 volts alternating current.

Light rope is a well understood term for a linear array of lights in a flexible, clear plastic housing running potentially many feet in length and connectable to additional lengths of rope light. Rope light is sold under the trademark FLEXLIGHT by Northwood Marine Services of Glasgow, Ky.; LL CROWN sold by American West Marketing, Inc., of Bozeman, Mont.; NEON ROPE sold by Neon Design A Sign of Laguna Niguel, Calif., as well as by many other manufacturers.

Typically, light rope 10 comes in lengths up to 150 feet with 0.455-watt bulbs operating off 6.5 volts and drawing 70 milliamps. The bulbs are spaced every inch and come in colors such as clear, red, blue, yellow, green, orange, purple and pink. Alternatively, light rope 10 may be based on the use of LEDs, rather than light bulbs. By cutting rope light 10 to the desired length and then applying fittings and connectors, rope light 10 can be terminated at the desired length, connected to a power cord or adapted to receive an additional length of rope light.

In the present application rope light 10 would be terminated in a cigarette lighter adapter 16. If rope light 10 is of the type of rope light that is driven by 12 volts, cigarette lighter adapter 12 is a simple adaptor. If rope light 10 is of a type that is driven by 110 volts AC, then cigarette lighter adapter must include a converter; that is, it would be terminated in a DC-to-AC (direct current to alternating current) converter formed to fit into a vehicular cigarette lighter and convert the 12 volts from the vehicular battery to 110 to 120 volts AC.

Frame 12 supporting light rope 10 may be made of any rigid, formable materials including metals, plastics and composites, preferably composites for both strength, rigidness, and lost cost of manufacturing. If made of metal, frame 12 is preferably made of a structurally strong and lightweight metal such as aluminum, aluminum alloy, or steel alloy. Alternately, rope light 12 can be manufactured to have a housing in the shape of the desired logo, player number, or other shape so that it is self-supporting.

Frame 12 is formed in the shape of a logo and preferably a team or player logo. A logo is a type of trademark, or technically a type of service mark, that indicates a source of goods or services. In the case of a sports logo, the logo is a mark indicating entertainment services in the nature of a sports team. A logo may typically have a visual element or aspect. For example, Clemson University uses a tiger paw as a logo. Racecar drivers may have numbers that function as marks.

Teams' and players' logos may be associated with team colors. The Clemson tiger paw is usually displayed in orange, the school color. When a logo is shown in the color that corresponds to the same team, the two are then consistent.

Preferably light rope 10 is secured in some convenient way to frame 12 such as by using wire tires 16 or clips but also by forming frame 12 so that it receives light rope 10 in a channel without blocking the light emanating from it from the side subject to view. Wire ties 16 are small, thin plastic “belts” with a running end and a “buckle” end that receives the running end and is formed to prevent the running end from sliding back out of the buckle. Wire ties 16, if used, are wrapped around light rope 10 and frame 12 to secure them to each other. Light rope 10 is secured so that it outlines frame 12, preferably on just one side of frame 12 rather than on both sides. Therefore, the length of frame 12 must correspond to the length of light rope 10; i.e., they must be of substantially the same length.

Light rope 10 has a series of bulbs 20 inside connected to two electrical leads 22 that can be cut when sizing light rope 10 to frame 12. Various connectors and fittings, well known to those familiar with light rope are used to terminate it or couple it to other fittings.

Suction cups 18 are attached to frame 12 to secure it and light rope 10 to a smooth surface such as glass or plastic. Preferably, suction cups 18 are clear plastic and are mounted on the front of the logo so that it can be secured to the inside of a window and permit the logo to be seen from outside the vehicle.

The present apparatus must be sized for typical vehicular windows. Preferably, the present apparatus would be not larger than a foot in diameter or on a side.

To make the present device, the user first forms frame 12 into the shape of a logo. Preferably, the logo is dimensioned to fit within the size of a car window. When holding formed frame 12 so that the logo is in its normal orientation, the viewer is looking at the front of frame 12 as opposed to the back of frame 12. Next suction cups 18 are attached to the front of frame 12 so that they will hold frame 12 to the inside of a window and the logo will be in its normal orientation when viewed from outside the window. Next, a length of rope light 10 is cut to the same length as frame 12 and a cigarette lighter adapter 14 is electrically connected to the end of rope light 10. Finally, rope light 10 is secured to frame 12 using clips or wire ties 16 so that rope light 10 outlines frame 12.

Those skilled in the art of spirit decorations and ornamental lighting will appreciate from the foregoing description that many modifications and substitutions can be made to the described preferred embodiments without departing from the spirit and scope of the present invention, defined by the appended claims.

What is claimed is:

1. A device, comprising:
a frame formed to represent a logo, said frame having a length;
light rope of a length corresponding to said length of said frame;
frame securing means for securing said light rope to said frame so that said light rope outlines said frame;
surface securing means for securing said frame to surface, said securing means being carried so that said frame can be secured facing said surface; and
means for providing electrical power to said light rope.

2. The device as recited in claim 1, said surface securing means are suction cups.

3. The device as recited in claim 1, wherein said logo is a sports team logo.

4. The device as recited in claim 1, wherein said frame is dimensioned for display through a car window.

5. The device as recited in claim 1, wherein said providing means is a cigarette lighter adaptor in electrical connection with said light rope.

6. The device as recited in claim 1, wherein said light rope is in a color that is consistent with said logo.

7. A device, comprising:
a frame formed to represent a logo, said frame having a length;
light rope of a length corresponding to said length of said frame and of a color consistent with said logo;
frame securing means for securing said light rope to said frame so that said light rope outlines said frame;
suction cups carried by said frame so that said frame can be secured facing a surface; and
a cigarette lighter adapter in electrical connection with said light rope.

8. The device as recited in claim 7, wherein said logo is a sports team logo.

9. The device as recited in claim 7, wherein said logo is a racecar driver number.

10. The device as recited in claim 7, wherein said frame is dimensioned for display through a car window.

11. A method for making a sign, said method comprising the steps of:
forming a frame into the shape of a logo, said frame having a front and a back;
attaching suction cups to the front of said frame;
attaching a cigarette lighter adaptor to a length of light rope;
attaching said length of light rope to said frame so that said rope light outlines said frame.
